(19) United States
(12) Patent Application Publication
(10) Pub. No.: US 2020/0402517 A1
(43) Pub. Date: Dec. 24, 2020

(54) METHOD AND SYSTEM TO ADAPT OPTIMAL PARAMETER SET TO COMMAND RECOGNITION PROGRAM BASED ON SPEAKER'S CONDITION

(71) Applicant: Hitachi, Ltd., Tokyo (JP)

(72) Inventors: Yusuke SHOMURA, Los Gatos, CA (US); Yasutaka SERIZAWA, Los Gatos, CA (US); Sudhanshu GAUR, Santa Clara, CA (US)

(21) Appl. No.: 16/449,001

(22) Filed: Jun. 21, 2019

(51) Int. Cl. G10L 17/22; G10L 25/84

(52) U.S. Cl. CPC G10L 17/22; G10L 25/84

(57) ABSTRACT

Example implementations are directed to maximizing the accuracy of command recognition in a noisy environment, such as a factor shop floor, by providing appropriate parameters and configurations to a speech recognition algorithm and a denoising algorithm based on an operator condition, such as the identified user and the location. Through the example implementations described herein, machine processes can be controlled through properly configured speech recognition and denoising algorithms despite having a surrounding noisy environment.

### BACKGROUND

### Field

The present disclosure is directed to factory systems, and more specifically, to voice recognition systems for factory floors.

### Related Art

Voice input has become popular due to the development of machine learning technologies. Nowadays, voice input is widely used in consumer use, such as in smart phones.

Voice input provides several benefits, such as ease of input and flexibility. In related art implementations, factory operators have attempted to utilize voice input method for machine operation. If such implementations can be realized, workers on the factory shop floor can easily collaborate with industrial machines and improve productivity.

However, one of the problems that occur on the factory floor is noise. A factory tends to have many machines and these machines cause different types of noise. Such noise degrades the accuracy of the command recognition. Further, machine operation requires high accuracy to prevent unintended operations, which might cause accidents.

There have been approaches to develop a voice recognition program which can apply various environments with different people. Typical machine learning base voice recognition programs involve a voice recognition algorithm and a parameter set which is calculated from a very large data set.

Such related art approaches are divided into an implementation to enhance the voice recognition algorithm, or to prepare and use a large data set including various types of noise and human voices. The first approach requires a lot of time to implementation. The other approach requires a large data set. Furthermore the data set should cover all kinds of factory environments.

### SUMMARY

Example implementations herein are directed to maintaining high accuracy for voice recognition even in a noisy environment surrounded by manufacturing machines. In example implementations described herein, there is an accuracy improvement method of command recognition via human voice from a system deployment viewpoint. In example implementations described herein, methods and systems are directed to maximize the accuracy of voice recognition in noisy factory shop floor by using appropriate parameter set based on the operator condition.

Aspects of the present disclosure can involve a method, involving executing a user check-in process to determine user identification and location information; applying parameters to a speech recognition algorithm and a denoising algorithm based on the user information and location information; and configuring a process to be controlled through the speech recognition algorithm and the denoising algorithm.

Aspects of the present disclosure can involve a computer program storing instructions for executing a process, the instructions involving executing a user check-in process to determine user identification and location information; applying parameters to a speech recognition algorithm and a denoising algorithm based on the user information and location information; and configuring a process to be controlled through the speech recognition algorithm and the denoising algorithm. The computer program can be stored in a non-transitory computer readable medium and configured to be executed by one or more processors.

Aspects of the present disclosure can involve a system, involving means for executing a user check-in process to determine user identification and location information; means for applying parameters to a speech recognition algorithm and a denoising algorithm based on the user information and location information; and means for configuring a process to be controlled through the speech recognition algorithm and the denoising algorithm.

Aspects of the present disclosure can involve an apparatus configured to control a machine, the apparatus involving a processor, configured to execute a user check-in process to determine user identification and location information; apply parameters to a speech recognition algorithm and a denoising algorithm based on the user information and location information; and configure the machine to be controlled through the speech recognition algorithm and the denoising algorithm.

### BRIEF DESCRIPTION OF DRAWINGS

FIG. 1 illustrates an example of an acoustic sensing system, in accordance with an example implementation.

FIG. 2(a) illustrates an example architecture of the management server, in accordance with an example implementation.

FIG. 2(b) illustrates an example of user management table, in accordance with an example implementation.

FIG. 2(c) illustrates an example of environmental value management table, in accordance with an example implementation.

FIG. 2(d) illustrates an example of running process management table, in accordance with an example implementation.

FIG. 3 illustrates an example flow chart for the user management program, in accordance with an example implementation.

FIG. 4 illustrates an example flow chart of the deploy management program, in accordance with an example implementation.

FIG. 5 illustrates example architecture of signal processing server, in accordance with an example implementation.

FIG. 6 illustrates a flow chart for the check-in detection program, in accordance with an example implementation.

FIG. 7 illustrates a flow chart of the command detection program, in accordance with an example implementation.

FIG. 8 illustrates an example of an over procedure and message format, in accordance with an example implementation.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

In an example implementation described below, the system selects an optimal parameter set based on the operator and operator location to keep the accuracy high and to reduce false positives.

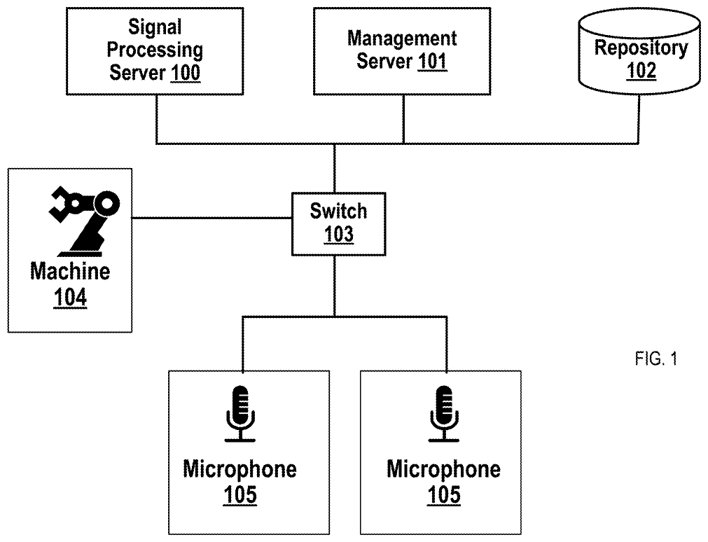

FIG. 1 illustrates an example of an acoustic sensing system, in accordance with an example implementation. In this example, there are one or more microphones 105 or other acoustic sensors depending on the desired implementation, a machine 104 such as a robotic arm or other mechanical manipulator, a repository 102, a signal processing server 100 and a management server 101 in the system. The microphones 105 sense acoustic information such as human voice and machine noise. The machine 104 can involve devices controlled by humans, such as robotic arms, belt conveyers, and other manufacturing or factory related devices. The repository 102 stores object files such as application programs and parameter sets, which is accessible from servers. The signal processing server 100 runs some programs which process acoustic data acquired from microphones 105. The management server 101 runs some management programs which manages user information, process status and object files. Each component is connected with each other via switch node 103.

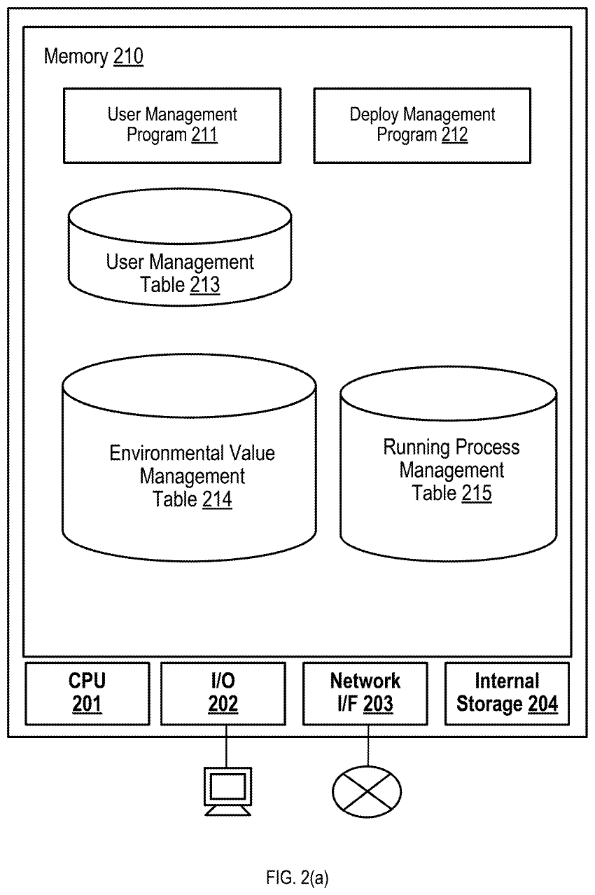

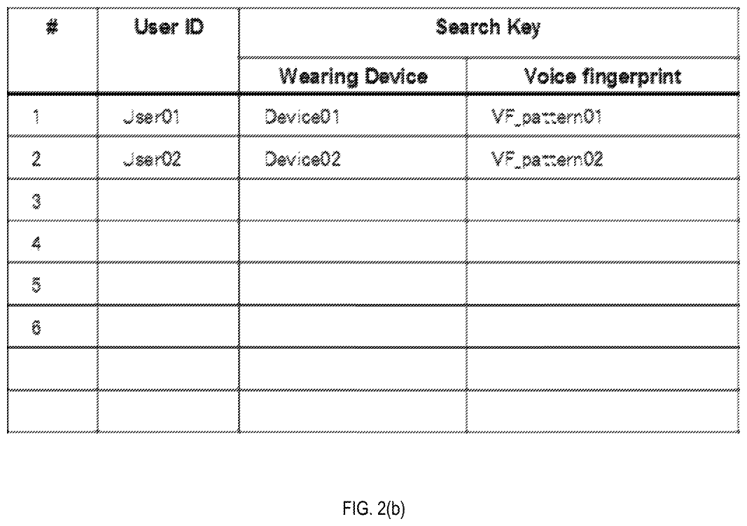

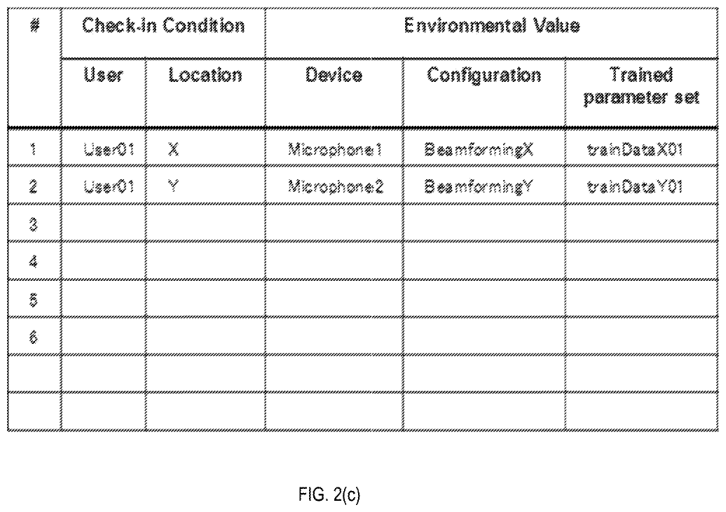

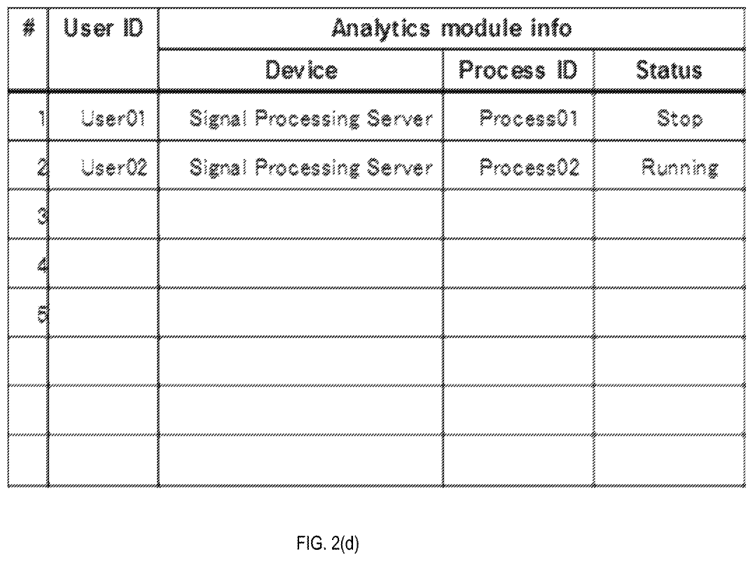

FIG. 2(a) illustrates an example architecture of the management server, in accordance with an example implementation. The management server can involve one or more physical hardware processors such as central processing unit (CPU) 201, Input/Output (I/O) 202, Network interface (I/F) 203, internal storage 204, and memory 210. I/O 202 is configured to receive input from a device such as touch screen, keyboard, mouse, and so on, and provide output on a display. Network I/F 203 facilitates the connection between the management server and other elements via the switch node as illustrated in FIG. 1. Internal Storage 204 may hold various data in accordance with the desired implementation.

Memory 210 may store user management program 211, deploy management program 212, user management table 213, environmental value management table 214 and running process management table 215. The user management program 211 is executed by CPU 201 when a User Identification Request is received. The deploy management program is executed by CPU 201 when a Check-in Request is received. The user management table 213 stores information regarding users who operate the manipulator. The environmental value management table 214 stores configuration data including the parameter set for each user and location. The running process management table 215 stores status of the process running on the signal processing server.

Further details of the elements of management server are described as follows.

FIG. 2(b) illustrates an example of user management table 213, in accordance with an example implementation. Each row of the table indicates user information. The table includes UserID and Search Key which represents user identification information. The UserID stores operator ID of the operator that is authorized to operate the machine. Examples of Search Key can include a worn device such as a badge, or voice fingerprint.

FIG. 2(c) illustrates an example of environmental value management table 214, in accordance with an example implementation. Each row of the table indicates the optimal environmental values for each check-in condition. The table includes the check-in condition and environmental value. The check-in condition involves User ID and Location. The user ID is related with the user ID of the User management table of FIG. 2(b). The location indicates the location or locations where a user conducts a check-in to the system. The environmental value involves the device, configuration and trained parameter set. The device indicates the optimal microphone device for the check-in condition based on the location of the check-in. The configuration includes beamforming parameter, such as azimuth, elevation and center frequency. The trained parameter set stores a pointer to an object file stored in the repository. The object file can contain information such as instructions indicating which denoising application programs to execute, and parameter sets associated with the corresponding application program (e.g., filter algorithms or functions to be selected within the corresponding application program, frequency filter settings, weights, a particular speech recognition algorithm with specific parameters such as settings for transform functions, etc.) that can be obtained previously from machine learning algorithms or preset according to the desired implementation.

FIG. 2(d) illustrates an example of running process management table 215, in accordance with an example implementation. Each row of the table indicates information of the process running on the signal processing server. The table includes User ID and Analytics module information. The user ID is related with the user ID of the User management table from FIG. 2(b). The analytics module information includes identification information, such as the device and process ID, and the status of the process. The device stores a device that is running the process. The process ID stores an identification of the process. The status indicates the running status of the process.

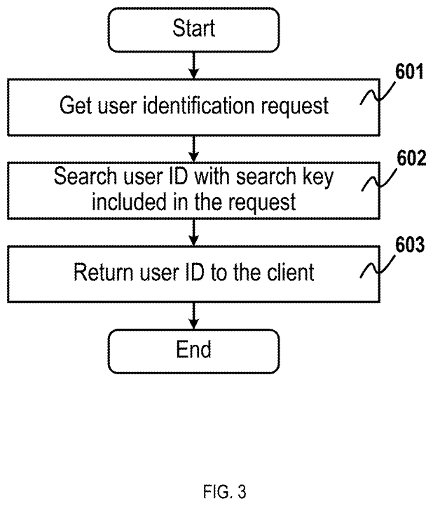

FIG. 3 illustrates an example flow chart for the user management program 211, in accordance with an example implementation. The program is executed whenever the program receives a user identification request. This program receives a user identification request at 601 and search for the user ID with the search key included in the request at 602. If such an entry corresponding to the user ID exists that corresponds to the search key, it return a message that includes user ID to the requested client at 603. If there is no entry to match the search key, it returns a message that indicates no user ID is found.

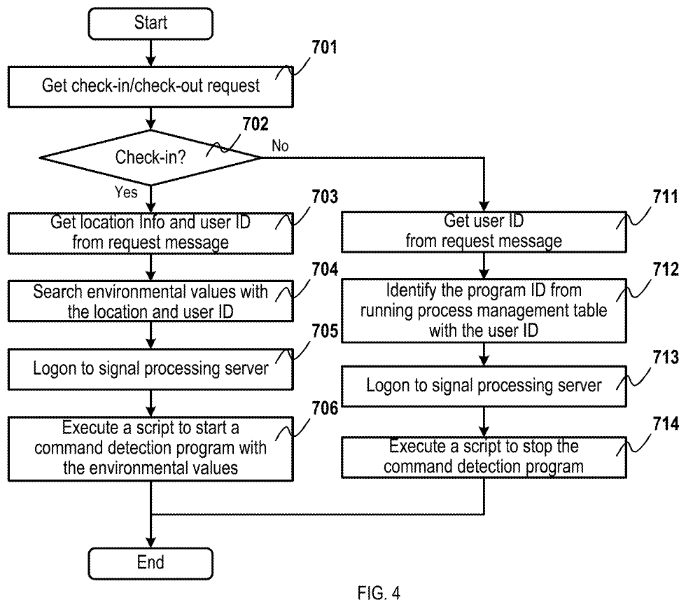

FIG. 4 illustrates an example flow chart for the deploy management program, in accordance with an example implementation. The program is executed whenever the program receives a check-in request. At 701, his program receives a check-in/check-out request and then checks the message type 702. If the message type is check-in (Yes), the flow proceeds to 703 to retrieve location information and user ID from the request message. Then at 704, the flow searches the environmental value management table and acquires environmental values matching the check-in condition. At 705, the program logs into the signal processing server to deploy a command detection program. Finally at 706, the program executes the command detection program with the environmental values acquired at 704.

If the message type is not a check-in (No) then the request is determined to be associated with a check-out procedure. In which case, the program retrieves the user ID from the request message at 711. At 712, the program searches running process management table and identifies the process ID with the user ID as a search key. At 713, the program conducts a login to the signal processing server to shut down the command detection program. Finally at 714, the program executes a script to stop the command detection program.

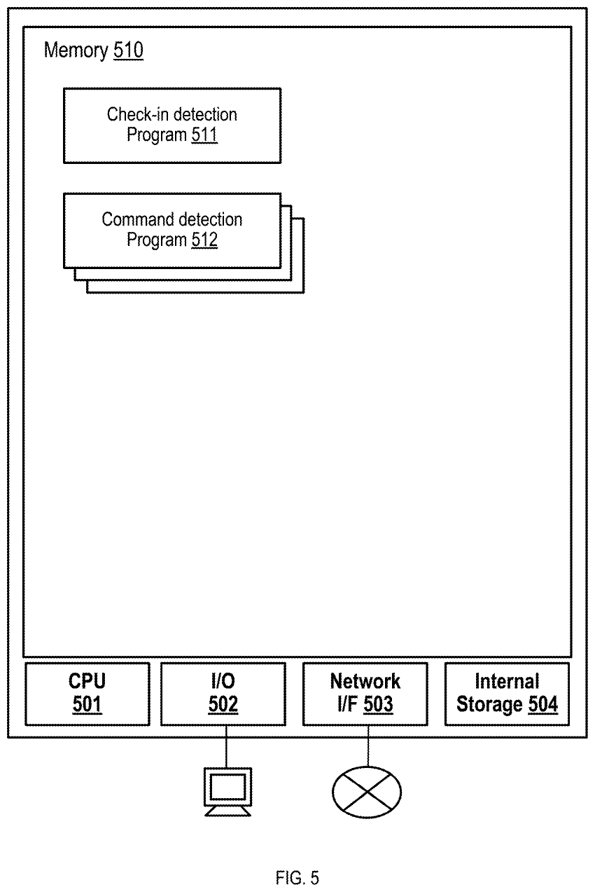

FIG. 5 illustrates example architecture of signal processing server 100, in accordance with an example implementation. Similar to the management server 101, signal processing server 100 can involve one or more physical hardware processors such as central processing unit (CPU) 501, Input/Output (I/O) 502, Network interface (I/F) 503, internal storage 504, and memory 510.

Memory 510 has check-in detection program 511 and several command detection programs 512. The check-in detection program 511 is executed when the server starts up. The command detection program 512 is executed by the deploy management program 212. The detail of each element is described as follows.

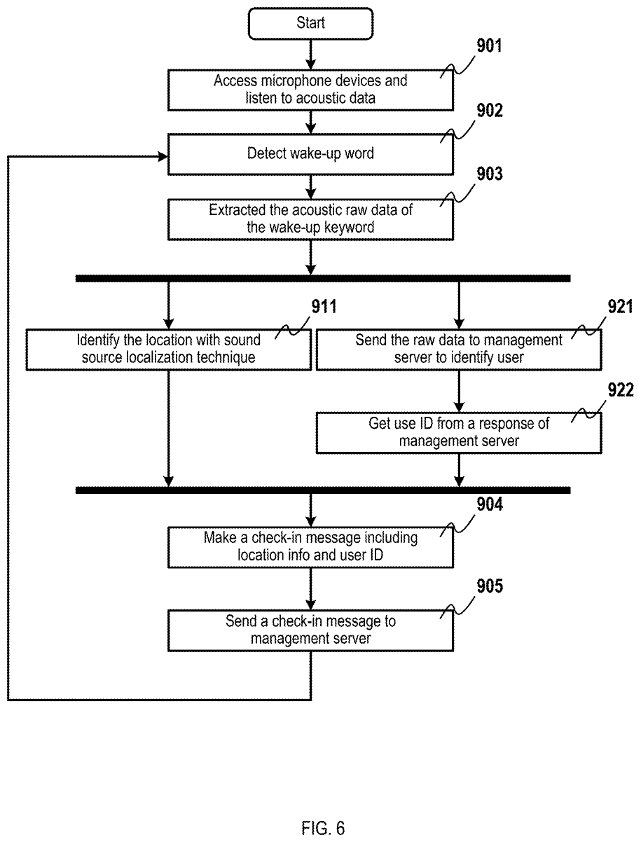

FIG. 6 illustrates a flow chart for the check-in detection program 511, in accordance with an example implementation. The program is executed when the server starts up. Initially, the program accesses microphone devices and continuously listens to the acoustic data from the microphone devices at 901. If the program detects a registered wake-up word to activate a voice control function for machine operation at 902, then the flow proceeds to 903 to extract the acoustic data of the wake-up word. Then, the program executes two kinds of identification processes in parallel.

The first process is to identify the user location. In this example, the program uses a sound source localization technique and identifies the user location at 911. The other process is to identify the user. In this example, the program uses the voice fingerprint to identify the user.

At 921, the program sends the raw data in a user identification request massage to the management server, and acquires the user ID in a response message from the management server at 922. After completing the parallel processes, the program generates a check-in message with location information and user ID at 904. Finally, the program sends the check-in message to the management server at 905.

As illustrated in FIG. 9, the user check-in process is associated with a check-in process for a machine,

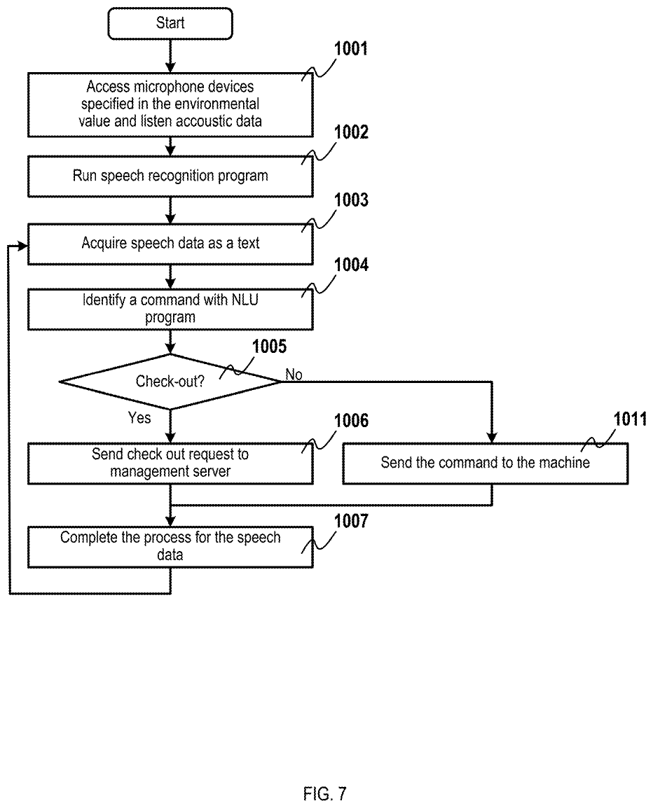

FIG. 7 illustrates a flow chart of the command detection program 512, in accordance with an example implementation. The program is executed by the deploy management program 212. At first, the program accesses microphone devices specified in the environmental values and listens to acoustic data at 1001. Then, the program executes a speech recognition program and applies the speech recognition to the listening data at 1002. If the speech recognition program detects speech, speech recognition program creates speech data as a text from acoustic data at 1003.

At 1004, the command detection program identifies a machine operational command from the speech data, which can be accomplished by utilizing Natural Language Understanding (NLU) algorithms.

At 1005, the command detection program checks for a command. If the command is determined to be a check-out command (Yes), the program sends a check-out request message to the management server at 1006. Otherwise (No), if the command is a command to operate machine, it sends the command to the machine at 1011. At 1007, the program completes the process of the speech data, and loops back to the flow at 1003 if more speech is detected.

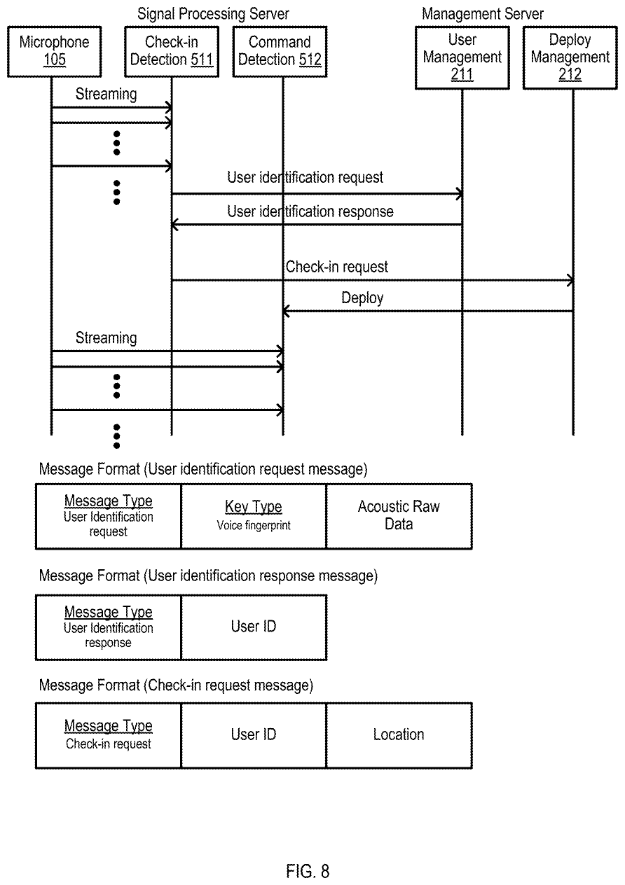

FIG. 8 illustrates an example of an over procedure and message format, in accordance with an example implementation. As illustrated in FIG. 8, at first, a check-in detection program 511 is executed when the signal processing server is invoked (e.g., booted up, when microphone 105 provides streaming data, etc.). The program 511 listens to acoustic data from microphones 105 and if the program 511 detects a check-in signal, it sends a user identification request to a user management program 211 running on the management server. If the user management program 211 receives a user identification request, the program 211 returns a user identification response to the check-in detection program 511. After the check-in detection program 511 gathers user information and check-in location information, it sends a check-in request message with such information to deploy management program 212 running on the management server. The management server receives the check-in request message, and deploys a command detection program 512 on the signal processing server. Then, the command detection program starts to obtain acoustic sensing data from the appropriate microphones. Such processes are executed whenever a new check-in event occurs.

In example implementations as shown in FIG. 8, check-in detection program 511 executes a user check-in process to determine user identification and location information as received from user management program 211. In example implementations as illustrated in FIG. 2(b), the user check-in process can involve detecting a wearing device (e.g., a badge, Quick release code or other code on a cellphone, a plug-in identification device, etc.) associated with a user, the information of which is transmitted to user management program 211 to retrieve the user identification and location information. Depending on the desired implementation, the location information can be obtained based on the device utilized to check in the wearing device, such as the machine to be operated, a badging station, a device/cellphone reader and so on. In another example implementation as illustrated in FIG. 2(b), the executed user check-in process can involve detecting voice through the microphone, in which a voice fingerprint is utilized to determine the user ID by user management program 211, and the location information can be determined based on the location of the microphone utilized, or the machine to be operated that is associated with the microphone. The voice fingerprint can be associated with a wakeup command for a particular machine, from which the user can be identified by user management program 211 based on comparing the audio to previously recorded voice fingerprints of users uttering the wakeup command. Further, the implementations provided are not limiting, and other implementations may be utilized if desired. For example, a camera may be utilized to detect a user from the video feed, wherein the location of the camera is utilized to obtain location information, and recognition algorithms (e.g., facial recognition) can be utilized to identify the user by user management program 211.

In example implementations, when the user management program 211 provides the user identification response to the check-in detection program 511 and the check-in process determines that the check-in is to be accepted, check-in detection program 511 can provide the check-in request to deploy management program 212, whereupon deploy management program 212 can provide the appropriate parameters for the command detection program 512 to execute a speech recognition algorithm and a denoising algorithm based on the user information and the location information. In an example as illustrated in FIG. 2(c), deploy management program receives the user and the location for check-in and determines the corresponding acoustic sensor (e.g., microphone), the configuration for the acoustic sensor, and the trained parameter set which is utilized by the speech recognition algorithm employed by command detection program 512.

In example implementations, a denoising algorithm can be applied along with a speech recognition algorithm by command detection program 512 to ensure clarity of the voice commands received through the acoustic sensor or microphone. For example, the denoising algorithm is configured to adjust the acoustic sensor according to the configuration received (e.g., azimuth, orientation, etc.), and also utilize the trained parameter set to filter out noise for the environment. Similarly, speech recognition algorithm is configured to adopt the parameters provided to recognize speech according to the parameters. In example implementations, the parameters can be generated from a machine learning algorithm configured to provide settings for the speech recognition algorithm and denoising algorithm based on the user and the location. In another example implementation, the trained parameter set and the configuration can be provided so that the speech recognition algorithm and denoising algorithm can be executed based on the machine to be controlled. In such an example implementation, the denoising algorithm can be configured from parameters that were generated from machine learning for when the machine was operating in normal conditions to determine what the underlying noise in the environment of the machine is like. In such an implementation, the denoising algorithm can thereby subtract the noise from the processed audio to filter out environment noise and leave the command audio from the user intact. Further, the speech recognition algorithm can be configured with parameters involving command sets specific to the machine, so that the speech recognition algorithm accuracy can be improved through being configured to only identify the commands associated with the machine to be controlled. Thus, depending on the desired implementation, the parameters can involve a selected microphone device associated with the location information, a beamforming parameter associated with the selected microphone device, and parameters associated with a selected application executing the denoising algorithm set based on the location information. Such parameters can be learned from a machine learning algorithm to generate a trained parameter set associated with the location to configure the speech recognition algorithm or the denoising algorithm in accordance with the desired implementation. The selected application can be a denoising algorithm selected from a plurality of denoising algorithms, and/or a speech recognition algorithm selected from a plurality of speech recognition algorithms.

In example implementations, the deploy management program utilizes the speech recognition algorithm and the denoising algorithm to process commands from speech received through the acoustic sensors or microphones and executes the process accordingly. In an example implementation, the process can be a control process for controlling a machine on the factory floor, wherein the machine executes processes based on the commands recognized by the command detection program 512.

However, the example implementations are not limited to controlling machine processes, and can be extended to other processes in accordance with the desired implementation. For example, the command detection program 512 can also execute a process to provide messages to the management server to check-out of a machine as illustrated in FIG. 7, or for situations when a user needs to send a message to another user or to the system to indicate a hazard (e.g., fire, flood, chemical spill, etc.). In such an example implementation, should a command detected be directed to transmitting a message to the management server, the command detection program 512 can also be configured to detect such commands with the NLU program and provide messages to the server according to the audio data received through the acoustic sensors.

Thus, through the example implementations described herein, it is possible to maximize the accuracy of command recognition in noisy factory shopfloor by using appropriate parameter set based on the operator condition.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method, comprising:
executing a user check-in process to determine user identification and location information;
applying parameters to a speech recognition algorithm and a denoising algorithm based on the user information and location information; and
configuring a process to be controlled through the speech recognition algorithm and the denoising algorithm.

2. The method of claim 1, wherein the user check-in process is associated with a check-in process for a machine, wherein the speech recognition algorithm and the denoising algorithm is executed based on the machine.

3. The method of claim 1, wherein the process comprises providing messages to a server through a microphone system.

4. The method of claim 1, wherein the process comprises a control process for controlling a machine.

5. The method of claim 1, wherein the user check-in process comprises detecting a badge associated with a user.

6. The method of claim 1, wherein the user check-in process comprises detecting a user through a video feed.

7. The method of claim 1, wherein the user check-in process comprises detecting, through a microphone associated with a machine, a wakeup command associated with the machine.

8. The method of claim 1, wherein the parameters comprises, a selected microphone device associated with the location information, a beamforming parameter associated with the selected microphone device, and parameters associated with a selected application executing the denoising algorithm set based on the location information.

9. A non-transitory computer readable medium, storing instructions for executing a process, the instructions comprising:
executing a user check-in process to determine user identification and location information;
applying parameters to a speech recognition algorithm and a denoising algorithm based on the user information and location information; and
configuring a process to be controlled through the speech recognition algorithm and the denoising algorithm.

10. The non-transitory computer readable medium of claim 9, wherein the user check-in process is associated with a check-in process for a machine, wherein the speech recognition algorithm and the denoising algorithm is executed based on the machine.

11. The non-transitory computer readable medium of claim 9, wherein the process comprises providing messages to a server through a microphone system.

12. The non-transitory computer readable medium of claim 9, wherein the process comprises a control process for controlling a machine.

13. The non-transitory computer readable medium of claim 9, wherein the user check-in process comprises detecting a badge associated with a user.

14. The non-transitory computer readable medium of claim 9, wherein the user check-in process comprises detecting a user through a video feed.

15. The non-transitory computer readable medium of claim 9, wherein the user check-in process comprises detecting, through a microphone associated with a machine, a wakeup command associated with the machine.

16. The non-transitory readable medium of claim 9, wherein the parameters comprises, a selected microphone device associated with the location information, a beamforming parameter associated with the selected microphone device, and parameters associated with a selected application executing the denoising algorithm set based on the location information.

17. An apparatus configured to control a machine, the apparatus comprising:
a processor, configured to:
execute a user check-in process to determine user identification and location information;
apply parameters to a speech recognition algorithm and a denoising algorithm based on the user information and location information; and
configure the machine to be controlled through the speech recognition algorithm and the denoising algorithm.
